(19) United States
(12) Patent Application Publication
(10) Pub. No.: US 2006/0049118 A1
(43) Pub. Date: Mar. 9, 2006

(54) Method of disinfection in water treatment

(76) Inventor: Antonio T. Robles, Kirkland Lake (CA)

Correspondence Address: Antonio T. Robles, 17 Furlong St.,, Kirkland Lake, ON, P2N3P5, CA

(21) Appl. No.: 10/935,391

(22) Filed: Sep. 8, 2004

(51) Int. Cl. C02F 1/50

(52) U.S. Cl. 210/753; 210/764

(57) ABSTRACT

A process is disclosed for the treatment of water to reduce the production of undesirable DBPs, such as THMs, when Fluo-chlorine is used as a disinfectant. The process replaces conventional chlorination with fluoride/chlorine mixtures that disinfect and fluoridate simultaneously.

### CROSS REFERENCES TO RELATED APPLICATIONS

Not Applicable

### BACKGROUND—FIELD OF INVENTION

This invention relates to the reduction of harmful disinfection by-products (DBPs) when mixtures of inorganic fluoride compounds and chlorine herein named “Fluo-chlorine” are used as a disinfectant in water treatment, specifically to the reduction of trihalomethanes (THMs) in treated water.

### BACKGROUND—DESCRIPTION OF PRIOR ART

For the past few decades, water utilities have been concerned about the presence of organic compounds in drinking water. It is essential that water utility operators understand the nature and source of the organics threat, and the growing body of drinking water regulations governing these compounds.

In 1974, researchers with the U.S. Environmental Protection Agency (EPA) and in the Netherlands published their findings that trihalomethanes are formed in drinking water when naturally occurring organic matter (NOM) is exposed to free chlorine (Equation 1). The family of trihalomethanes (THMs) and haloacetic acids (HAAs) are the most common forms of chlorine disinfection by-products (DBPs). Trihalomethanes are a class of organic compounds where there has been a replacement of three hydrogen atoms in the methane molecule with three halogen atoms (chlorine or bromine). The four most commonly found THMs are chloroform, bromoform, bromodichloromethane, and dibromochloromethane.

$$Equation 1 \text{:}$$

$$Free chlorine and \text{/} or bromine + organic precursors -> Trihalomethanes + Haloacetic acids + By \text{-} product compounds$$

The naturally occurring organic precursors generally are humic substances, such as, humic and fulvic acids.

Because the health implications of DBPs are better understood, the current DBP regulatory emphasis is on halogenated organic groups like THMs and HAAs. It is important to note that all oxidants and disinfectants can produce DBPs.

Developing a DBP control strategy requires planning. Regulatory agencies favor those strategies involving removal of DBP precursors prior to chlorine addition. This may involve optimizing existing processes or adding new processes to remove NOM. Many utilities instituted a switched from chlorine to alternative disinfectants, such as ozone (Chowdhury, U.S. Pat. No. 6,673,248), and chloramines. A limited number of utilities have installed processes, such as aeration (Halder et al, U.S. Pat. No. 6,277,175), that remove THMs after their formation.

Research began on the nature of the reactions producing THMs, the concentrations considered unacceptable in drinking water, and methods to reduce or prevent their formation.

Three general strategies (or a combination thereof) are available for reducing DBPs in drinking water supplies:
Remove the DBPs after they are formed.
Use a disinfectant-oxidant other than chlorine that does not produce undesirable DBPs.
Remove the natural organics (precursors) before disinfection-oxidation.

Of these, the first two may be faulted for not treating the problem but dealing only with symptoms. The third strategy gets to the root of the problem itself—natural organics or precursor found in raw water.

Aeration and adsorption have been used successfully to remove THMs after they are formed. However, their costs are high and the efficiency of removing THMs is poor. It is also possible that these two processes can bring significant contamination into the finished water.

Walterick, Jr., et al., U.S. Pat. No. 4,661,259 tried to use powdered activated carbon (PAC) and cationic polymers to reduce THM precursors in raw water. Similarly, Van de Venter, U.S. Pat. No. 5,154,834 tried adding bentonite in addition to PAC and polymer. Nguyen, et al., U.S. Pat. No. 6,669,849 tried to reduce total organic carbon (TOC) in water using ion-exchange resin.

McCarthy, U.S. Pat. No. 4,385,996 tried to use reducing agents such as sulfite or sulfur dioxide with chlorination to control trihalomethanes in water.

Switching to alternative disinfectant-oxidants may be feasible provided the following criteria are met:
DBPs are not produce at undesirable levels.
Microbial inactivation is at least as effective as disinfection with chlorine.
A stable disinfecting residual is provided in the distribution system.

From the economic standpoint, the ideal alternative disinfectant-oxidants should be no more expensive than chlorine. Unfortunately, on a cost basis, free chlorine is by far the most effective disinfectant. Moreover, no single alternative disinfectant-oxidant can satisfy all of the above requirements. Hence, to replace chlorine, a combination of disinfectant-oxidant is usually needed.

Removal of natural organics, or precursor materials, prior to disinfection represents an optimal approach for controlling DBPs. Because precursor materials are constituents of the total organic carbon (TOC) in raw water, optimizing treatment to remove TOC before adding disinfectant-oxidant provides the best strategy for reducing DBPs. Treatment technologies to remove NOM include conventional treatment, oxidation, adsorption, and membrane processes.

Studies at many water treatment plants have revealed that a significant reduction of total organic carbon (TOC) in source water by chemical coagulation often shows very little effect on total trihalomethane (TTHM) formation. Powdered activated carbon and granular activated carbon used for taste and odor control can have a limited impact on the removal of THMs and THM precursors.

While chlorine gas remains the most commonly used water disinfectant, a number of chlorine and non-chlorine alternatives are available.

Chlorine gas, also known as elemental chlorine, is a powerful oxidizing and disinfecting agent that is transported and stored as a liquefied gas under pressure. Water treatment facilities typically use chlorine in 150-lb cylinders or one-ton containers. Some large systems use 90-ton railroad tank cars.

Sodium hypochlorite (often referred to as liquid bleach) is a chemical compound used to add chlorine to water. It is transported and stored in solutions containing 5% to 20% chlorine. It can be generated on site, but is more commonly shipped by truck in containers ranging from 55 to 5,000 gallons.

Calcium hypochlorite is another chlorinating chemical. It is available in granular and tablet forms.

Chloramines are chemical compounds formed in the water by combining chlorine in a specific ratio with ammonia.

Ozone is a powerful oxidizing and disinfecting agent generated on-site by passing oxygen or dry air through a system of high voltage electrodes.

Ultraviolet (UV) radiation is generated by special lamps. It disinfects by penetrating the cell wall of an organism and hindering its ability to reproduce.

Chlorine dioxide is a powerful disinfectant and oxidizer generated on-site. Although it contains chlorine atoms, it disinfects through a different mechanism than chlorine.

Fluo-chlorine is an excellent disinfectant of this invention. It is a powerful oxidizer, disinfectant, and fluoridates the water. It is prepared by adding inorganic fluoride compounds into a solution of chlorine or hypochlorite salts.

Some systems use a combination of disinfectants. For example, a system using ozone for initial treatment may use chlorine for subsequent treatment to maintain disinfection “residual” in the water distribution system. Table 1 below summarizes the advantages and limitations of water treatment disinfectants.

TABLE 1
Disinfectants advantages and limitations

| Disinfectant | Advantages | Limitations |
|---|---|---|
| Chlorine Gas | Highly effective against most | Byproduct formation (THMs, HAAs) |
| | pathogens | Special operator training needed |
| | Provides “residual” protection | Additional regulatory requirements |
| | required for drinking water | (EPA Risk Management |
| | Operationally reliable | Program) |
| | Generally cost-effective option | Not effective against |
| | | Cryptosporidium |
| Sodium hypochlorite | Same efficacy and residual protection | Limited shelf-life |
| | as chlorine gas | Same byproducts as chlorine gas, |
| | Fewer training requirements than | plus bromate and chlorate |
| | chlorine gas | Higher chemical cost than chlorine |
| | Fewer regulations than chlorine | gas |
| | gas | Corrosive; requires special |
| | | handling |
| Calcium hypochlorite | Same efficacy and residual protection | Same byproducts as chlorine gas |
| | as chlorine gas | Higher chemical costs than |
| | Much more stable than sodium | chlorine gas |
| | hypochlorite, allowing long-term | Fire or explosive hazard if handled |
| | storage | improperly |
| | Fewer Safety Regulations | |
| Chloramines | Reduced formation of THMs, HAAs | Weaker disinfectant than chlorine |
| | More stable residual than chlorine | Requires shipments and use of |
| | Excellent secondary disinfectant | ammonia gas or compounds |
| | | Toxic for kidney dialysis patients |
| | | and tropical fish |
| Ozone | Produces no chlorinated THMs, HAAs | More complicated than chlorine or |
| | Effective against Cryptosporidium | UV systems |
| | Provides better taste and odor control | No residual protection for drinking |
| | than chlorination | water |
| | Fewer safety regulations | Hazardous gas requires special |
| | | handling |
| | | Byproduct formation (bromate, |
| | | brominated organics and |
| | | ketones) |
| UV | No chemical generation, storage, or | No residual protection for drinking |
| | handling | water |
| | Effective against Cryptosporidium | Less effective in turbid water |
| | No known byproducts at levels of | No taste and odor control |
| | concern | Generally higher cost than chlorine |
| Chlorine dioxide | Effective against Cryptosporidium | Byproduct formation (chlorite, |
| | No formation of THMs, HAAs | chlorate) |
| | Provides better taste and odor control | Requires on-site generation |
| | than chlorination | equipment and handling of |
| | | chemicals |
| | | Generally higher cost than chlorine |
| Fluo-chlorine of this | Highly effective against pathogens | Special operator training needed |
| invention | Provides “residual” protection | Corrosive; requires special |
| | required for drinking water | handling |
| | Less byproduct formation | |
| | Operationally the most reliable | |
| | Generally the most cost-effective | |
| | option | |

Trihalomethanes (THMs),
Haloacetic Acids (HAAs)

Chlorine remains the overwhelming choice for drinking water disinfection. Its effectiveness against a wide spectrum of disease causing organisms, relatively low cost, high reliability, and ease of operation contribute to its popularity. Because of the trade-offs associated with alternative disinfectants, changing technologies will not necessarily improve overall safety and security.

Chlorination practices will continue to be under scrutiny as more is learned about the effects of the disinfection process and the resulting DBPs. Operation of surface water treatment plants and the quality of water they produce will be examined in ever-increasing detail. New processes that will remove precursors will be discovered and used successfully.

Whatever the development, it is expected that chlorination will survive and perhaps become enhanced as the process is more thoroughly understood and used more efficiently.

In summary, prior methods of reducing THMs called for:
aeration after the THMs were formed;
reduced prechlorination or none at all;
the use of alternative disinfectant-oxidant, such as ozone or chloramines;
the use of membrane filtration;
improved conventional treatment—flocculation, coagulation, sedimentation, and filtration;
adsorption of THMs using activated carbon; or
combination of the above treatment.

These prior methods had the following disadvantages:
requires more process equipment;
high cost of reagents and/or equipment;
more complex processes with little significant reduction of THMs in finished water;
high capital and operating cost; or
added processes negatively affect existing processes.

Thus, there is a need for a low cost, and effective process for reducing THMs in treated water. My invention fills that need.

### SUMMARY

The present invention shows that an effective way of reducing THMs in treated water is to use fluoride/chlorine mixture (Fluo-chlorine) as the primary disinfectant instead of chlorine. This invention is very advantageous since solutions of fluoride salts and chlorine are commonly available in a conventional water treatment plant and therefore do not require capital expenditures or significant process changes.

### OBJECTS AND ADVANTAGES

Accordingly, besides the objects and advantages of using Fluo-chlorine as the primary disinfectant described in my above patent, several objects and advantages of the present invention are:
provides an effective THM and other DBPs reduction process;
provides a process that is simpler and cheaper to operate than other alternate processes;
provides a process that can be easily adapted to existing processes;
provides a process free of the complexities associated with other processes;
provides a process that will not affect the operation of existing processes; and
provides a low cost and effective process.

The description and drawings below show additional objects and advantages.

### BRIEF DESCRIPTION OF THE DRAWINGS

Not Applicable

### REFERENCE NUMERALS

Not Applicable

### PREFERRED EMBODIMENT—DESCRIPTION

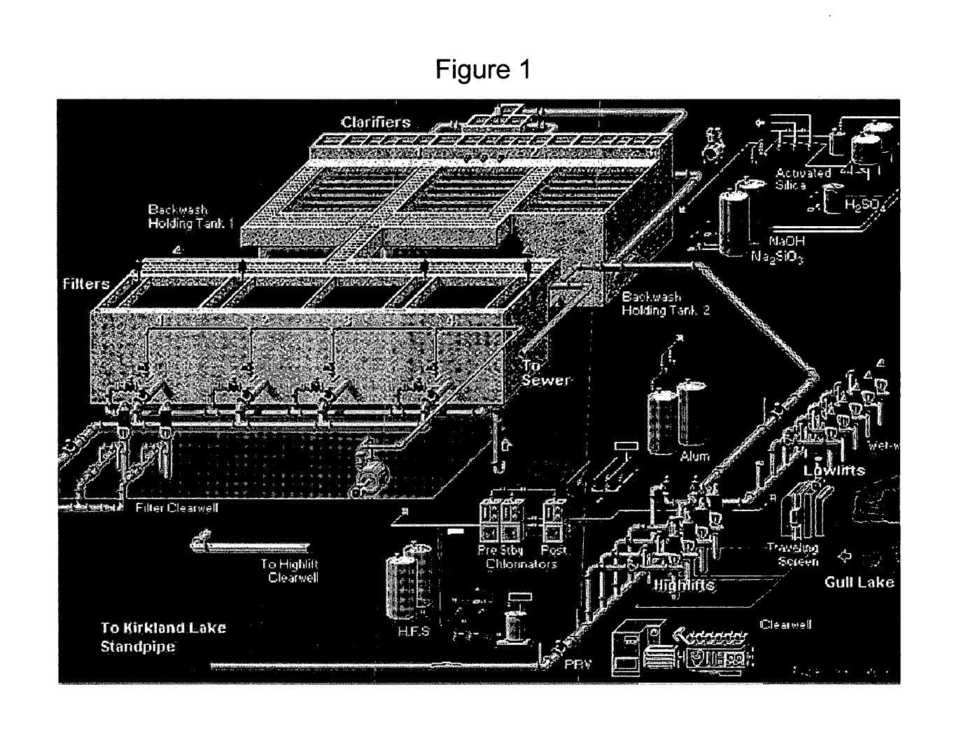

A preferred process involving selected major operations is shown in FIG. 1. Fluoride solution is mix with chlorine using the chlorinator injector discharge line leading the mixture to the chlorinator diffuser. In essence, fluoride may be added anywhere where chlorine is added to the water.

### PREFERRED EMBODIMENT—OPERATION

This part describes how my invention operates in reference to FIG. 1.

As indicated in FIG. 1, raw water enters the well where it is prechlorinated (optional). The low-lift pump (LLP) transfers the raw water from the well to the treatment area where alum (a coagulant) is rapidly mixed using a flask mixer. Coagulation proceeds rapidly and immediately followed by flocculation. Most plants have separate flocculation and sedimentation equipment. Some plants have flocculation and sedimentation (clarifier) occurring on the same equipment, such as the Degremont Super Pulsator shown in FIG. 1. Flocculating agent such as activated silica or synthetic polymer is added before the flocculation/sedimentation equipment. The clarifier effluent goes to the filters and into the clear well. The treated water is then chlorinated and fluorinated simultaneously using a mixture of fluoride and chlorine solution preferably below pH 9. Table 2 shows the chronological steps in water treatment in a typical water treatment plant.

TABLE 2
Chronological steps in water treatment

| Item/Equipment | Description |
|---|---|
| Raw water (RW) | Surface or ground water |
| Screens | Removes debris that could damage process |
| | equipment |
| Pre-chlorinator Diffuser | Pre-chlorination (pre-Fluo-chlorination may |
| | be used instead). Optional |
| Low lift pump (LLP) | Transfer raw water from the RW well to |
| | downstream water treatment equipment |
| Flash Mixer | Injection point for coagulant (alum, iron |
| | salts) |
| Coagulation/Flocculation | Injection point for flocculant (activated |
| | silica, synthetic polymers) |
| Flocculation/Sedimentation | Continued flocculation and settling out |
| | of flocs in the clarifier |
| Filtration | Filters out remaining particles from clarifier |
| | effluent |
| Clear Well (CW) | Stores filtered/treated water |
| CW Chlorine Diffuser | Chlorination of treated water (Fluo- |
| | chlorination may be used instead) |
| CW Caustic Diffuser | Control the pH of finished water |
| CW Fluoride Diffuser | Fluoridation of treated water as commonly |
| | practice (Not required when Fluo- |
| | chlorination is practiced) |

A conventional water treatment plant may add chlorine before (prechlorination) and after (post chlorination) water treatment (coagulation, flocculation, sedimentation, and filtration). THMs formation occurs where THM precursors are present and chlorination is practiced.

THM formation is significantly reduced when Fluo-chlorination is used instead of chlorination. Fluo-chlorination disinfects as well as fluoridates the treated water; this process should be distinguished from the current practice of fluoridation.

Fluoridation is the deliberate adjustment of the fluoride concentration in a drinking water supply. It is done to maintain an optimal level of fluoride needed by children to develop teeth resistant to tooth decay.

Fluoride is an ion originating from the element fluorine. It is a constituent of the earth's crust and consequently found naturally, to some degree, in all drinking water sources. A small amount of fluoride in the diet is essential for proper tooth and bone formation.

To achieve maximum benefits of fluoridation, the optimal concentration of fluoride in the water supply must be continuously maintained. A drop of only 0.3 mg/L below optimal can reduce fluoride's benefits by as much as two thirds. However, concentrations above 1.5 mg/L over the optimal level do not significantly reduce tooth decay any further and can cause mottling of the teeth.

The three chemical compounds used in fluoridation are: sodium fluoride, fluorosilicic acid, and sodium fluorosilicate. The chemical cost of fluoridation is very small because of the small quantities of chemicals required to maintain optimal dose in relation to the overall operation of the treatment plant.

The fluoride injection point is located so that the chemical is applied after water has received complete treatment. In particular, the fluoride compound is not added to the water before or during the addition of a disinfectant.

In the practice of Fluo-chlorination, the amount of fluoride and chlorine in the mixture is controlled independent of each other. Fluoride dose is maintained within regulatory requirements, such as, 0.50 to 0.80 mg/L, and the chlorine dose depends on chlorine demand to maintain proper chlorine residual. The preferred pH of Fluo-chlorination is below pH 9 preferably at pH 6.

### EXAMPLE 1

The laboratory scale test will be explained in reference to Table 3. The raw water was prechlorinated, such that, the amount of chlorine added to the raw water was not enough to produce the maximum THMs potential of the sample. This explains the lower value for the A1 sample when compared to the A2 and A3 samples.

TABLE 3
Laboratory scale test results

| | | | Spiked with 0.84 ppm |
|---|---|---|---|
| | | Spiked with 0.84 ppm | Free Chlorine plus |
| | Control | Free Chlorine | 1.96 ppm Fluoride |
| Prechlorinated Raw Water - A | Sample ID: A1 | Sample ID: A2 | Sample ID: A3 |
| (Total chlorine = 0.7 ppm) | THMs = 3.4 ppm | THMs = 10.7 ppm | THMs = 5.5 ppm |
| (Free chlorine = 0.0 ppm) | | | |
| Filter Effluent - C | Sample ID: C1 | Sample ID: C2 | Sample ID: C3 |
| (Total chlorine = 0.7 ppm) | THMs = 1.9 ppm | THMs = 8.7 ppm | THMs = 6.8 ppm |
| (Free Chlorine = 0.0 ppm) | | | |
| Post chlorinated Treated | Sample ID: D1 | Sample ID: D2 | Sample ID: D3 |
| Water - D | | | |
| (Total chlorine = 1.9 ppm) | THMs = 11.4 ppm | THMs = 13.5 ppm | THMs = 11.2 ppm |
| (Free Chlorine = 1.3 ppm) | | | |

There was a significant drop in THMs in sample A3 where fluoride was added versus A2. On sample series C and D, lesser drop in THMs were observed because these samples had gone through the water treatment process before the fluoride was added.

In this example, laboratory grade hydrofluoric acid was used instead of the commonly used fluorosilicic acid. The difference between the two acids is that the fluorosilicic acid contains silicon.

### EXAMPLE 2

This example is a plant scale test of Fluo-chlorination.

On May 25, 2004, a treated water sample (Sample 1) was collected to provide THMs values before fluorosilicic acid was mixed with chlorine. After this initial sampling, fluorosilicic acid was injected into the post chlorinator injector discharge line to provide primary disinfection.

On May 31, 2004, and Jun. 7, 2004, treated water samples (Sample 2 and 3 respectively) were collected for THMs analysis. Fluo-chlorination was on-line. Unfortunately, on Jun. 9, 2004, a leak developed on the fluorosilicic acid line and the addition of fluorosilicic acid to chlorine was discontinued. Standard chlorination with chlorine was established.

While the water treatment plant was on standard chlorination, Sample 4 was collected on Jun. 15, 2004 and sent for THMs analysis. Additional sampling was done on Jun. 21, 2004 (Sample 5) for THM analysis. These samples did not received Fluo-chlorine treatment because of the June 9 incident.

On Jun. 23, 2004, Fluo-chlorination was re-established after repairing the leak on the fluorosilicic acid pipe. Plant treated water sample (Sample 6) was collected on Jun. 28, 2004 and sent for THMs analysis.

The above sampling and the results of THMs analysis are summarized in Table 4.

TABLE 4
Plant treated water sample test results

| | | Lab A Results | Method of |
|---|---|---|---|
| Sample ID | Date Samples | THMs in ppb | Disinfection |
| Sample 1 | May 25, 2004 | 146 | Chlorination |
| Sample 2 | May 31, 2004 | 94 | Fluo-chlorination |
| Sample 3 | Jun. 7, 2004 | 42 | Fluo-chlorination |
| Sample 4 | Jun. 15, 2004 | 150 | Chlorination |
| Sample 5 | Jun. 21, 2004 | 134 | Chlorination |
| Sample 6 | Jun. 28, 2004 | 87 | Fluo-chlorination |

### EXAMPLE 3

The laboratory scale test using fluorosilicic acid was used, as the source of fluoride ion, will be explained in reference to Table 5. A filtered sample that has undergone conventional water treatment using alum and activated silica was used to determine the TTHM potential using chlorination and Fluo-chlorination.

TABLE 5
TTHMs Potential vs. Detention Time

| | | Fluo-chlorination using |
|---|---|---|
| Detention time | Chlorination using | 11 ppm chlorine and 1.2 ppm |
| (hours) | 11 ppm free chlorine | fluoride |
| 18 | TTHM Potential: | TTHM Potential: |
| | 68 ppb | 54 ppb |
| 36 | TTHM Potential: | TTHM Potential: |
| | 129 ppb | 113 ppb |
| 54 | TTHM Potential: | TTHM Potential: |
| | 131 ppb | 109 ppb |

### CONCLUSIONS, RAMIFICATIONS, AND SCOPE

It is clear that Fluo-chlorination reduces the formation of undesirable DBPs such as THMs.

My method of reducing THMs in treated water extends present knowledge of water treatment chemistry. Furthermore, my method has additional advantages over prior art in that:
it allows the use of commonly available reagents;
it provides a simple and low cost treatment process;
it provides a process that does not complicate the operation of the existing process;
it does not require large capital expenditures; and
it provides a simple, economical, and efficient method of reducing THMs in treated water.

The specific data in the examples described above are merely illustrative; they do not limit the scope of the invention. Various ramifications are possible within the scope of the invention. For example, fluorine may be use as the source of the fluoride ion. Fluorine has the advantage of being a stronger oxidizer than chlorine and therefore can significantly reduce THM precursors. The fluoride may be added ahead of prechlorination or anywhere in the treatment process. Prefluoridation without prechlorination may be used.

Thus, the scope of the invention should be determined by the appended claims and their legal equivalents, rather than by the examples given.

I claim:

1. In a process for treating water with a disinfectant, a method of reducing the formation of disinfection byproducts wherein a fluoride ion is added before or during a disinfection process.

2. The process of claim 1 wherein said disinfection process use chlorine or hypochlorite solutions or both.

3. The process of claim 1 wherein said disinfection byproducts are selected from the group consisting of trihalomethanes or haloacetic acids, or both.

4. The process of claim 1 wherein said fluoride ion is selected from the group consisting of hydrofluoric acid, sodium fluoride, calcium fluoride, sodium fluorosilicate, fluorine, and fluorosilicic acid.
